(19) United States
(12) Patent Application Publication
(10) Pub. No.: US 2008/0001939 A1
(43) Pub. Date: Jan. 3, 2008

(54) METHOD OF GENERATING VIDEO DRIVING SIGNAL AND APPARATUS THEREOF

(76) Inventors: Ching-Tzong Wang, Kao-Hsiung City (TW); Yen-Hung Chen, Hsin-Chuang City (TW)

Correspondence Address: NORTH AMERICA INTELLECTUAL PROPERTY CORPORATION, P.O. BOX 506, MERRIFIELD, VA, 22116, US

(21) Appl. No.: 11/768,193

(22) Filed: Jun. 25, 2007

(30) Foreign Application Priority Data
Jun. 27, 2006 (TW) 095123128

(51) Int. Cl. G09G 5/36; G09G 3/36

(52) U.S. Cl. 345/204

(57) ABSTRACT

A method of generating a video driving signal is disclosed. The method includes: compressing the first image data to generate a compressed data; delaying the compressed data; decompressing the compressed data to generate a decompressed image data; and comparing a second image data and the decompressed image data to generate an overdrive signal; wherein the overdrive signal corresponds to the second image data.

### DESCRIPTION

1. Field of the Invention

The present invention is related to an image displaying controller, and more particularly to an image displaying controller that utilizes an overdrive signal, and a method thereof.

2. Description of the Prior Art

Liquid crystal molecules have different polarization and refraction of light due to different alignment, so the amount of light transmitted can be controlled, generating light with different strengths. This is how an LCD panel displays different gray-level strengths of red, blue, and green light to produce images.

When applying an electric field to liquid crystal molecules to change their alignment, it takes some time to reach the final state due to the properties of the molecules, thus causing output delay of the display. Therefore, overdrive technology is adopted to solve the problem of low response time of an LCD. In relevant art, overdrive technology in general uses a look up table (LUT) to store the target gray-level value of each gray-level transformation, where the target gray-level is used to shorten the transformation time that a pixel changes from a first gray-level to a second gray-level on a display panel.

Please refer to FIG. 1. FIG. 1 is a prior art overdrive system 30. When the video data Glᵢₙ is inputted to the overdrive system 30, the frame buffer 300 stores a previous video data, then inputs the previous video data and the current video data into a look-up table 302 to determine the amount of the overdrive signal GLₒᵤₜ. Therefore, when the resolution of the displaying apparatus increases, the storing capacity of the frame buffer 300 should be increased accordingly. For example, when the resolution of the displaying apparatus is 1024*768 pixels, and if each of the three colors red, blue, green (RGB) is represented in 6 bits, the capacity of the frame buffer 300 needs 1024*768*3*6 bits (1.73 MB). Furthermore, the look-up table 302 also requires a memory that has 64*64*3 bits. Those skilled in this art will know that the cost of the memory is the main cost of fabricating a displaying apparatus. Therefore, according to the above-mentioned method, the prior art overdrive system 30 needs a large memory capacity, increasing the cost of the displaying apparatus.

### SUMMARY OF THE INVENTION

Therefore, one of the objectives of the present invention is to provide a method that compresses/decompresses video data in order to save the memory capacity of generating an overdrive signal and apparatus thereof, which will save the cost of the displaying apparatus.

According to an embodiment of the present invention, a video driving signal generating method disclosed. The method comprises: compressing a first image data to generate compressed data; buffering the compressed data; decompressing the compressed data to generate a decompressed image data; comparing a second image data and the decompressed image data to generate a comparing result; and generating a video driving signal according to the second image data and the comparing result; wherein a difference value between the second image data and the video driving signal corresponds to the second image data.

According to another embodiment of the present invention, a video driving signal generating apparatus is disclosed. The apparatus comprises a compressing unit, a buffering unit, a decompressing unit, and a comparing unit. The compressing unit is utilized for compressing a first image data to generate a compressed data; the buffering unit is utilized for buffering the compressed data; the decompressing unit is utilized for decompressing the compressed data to generate a decompressed image data; and the comparing unit is utilized for comparing a second image data and the decompressed image data to generate a video driving signal; wherein the video driving signal corresponds to the second image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a prior art overdrive system.

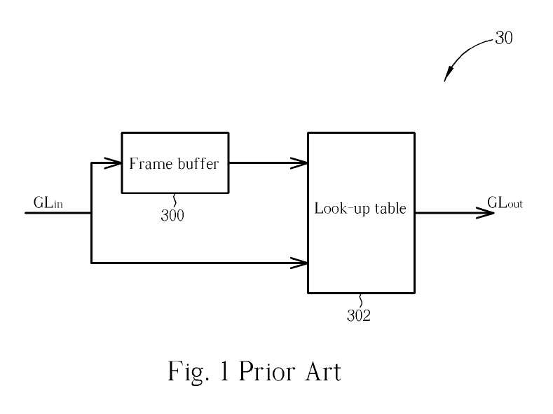

FIG. 2 is a diagram illustrating an overdrive system according to an embodiment of the present invention.

FIG. 3 is a flowchart illustrating the compression of the first image data by utilizing the first algorithm of the compressing apparatus in FIG. 2.

### DETAILED DESCRIPTION

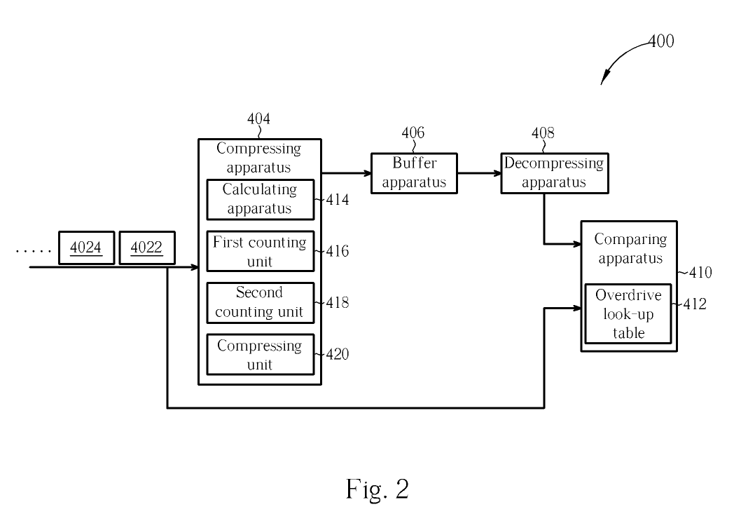

Please refer to FIG. 2. FIG. 2 illustrates an overdrive system 400 according to an embodiment of the present invention. The overdrive system 400 comprises a compressing apparatus 404, a buffering apparatus 406 (e.g. a first-in-first-out [FIFO ] frame buffering memory), a decompressing circuit 408, and a comparing apparatus 410. In order to clearly describe the overdrive system 400 of the present invention, the resolution of the video image is assumed to be 1024*768 in the following description, and the gray level of each of the red, blue, and green (RGB) colors is recorded by 6 bits. However, it is well known by those skilled in this art that the disclosure of the present invention can also be applied in other field and image specifications, and is not limited by the following description. The overdrive system 400 of the present invention receives a first image data 4022 and a second image data 4024 at the front end circuit, wherein the timing of the first image data 4022 is earlier than the second image data 4024. When the compressing apparatus 404 receives the first image data 4022, the compressing apparatus 404 utilizes an algorithm to compress the first image data 4022 to generate a compressed image data, the data size of the compressed image data being smaller than the first image data 4022. The compressing apparatus 404 comprises a calculating apparatus 414, a first counting unit 416, a second counting unit 418, and a compressing unit 420. Please note that a detailed description of the compressing apparatus 404 is given in the following disclosure.

Due to the fact that there is a timing difference between the first image data 4022 and the second image data 4024, and the compressing apparatus 404 and the decompressing circuit 408 both require some time to operate, the buffering apparatus 406 is utilized for buffering the first image data 4022 in order to let the comparing apparatus 410 process the first image data 4022 and the second image data 4024 at the right time. In other words, the buffering apparatus 406 is utilized for compensating for the above-mentioned timing difference and the operation time of the compressing apparatus 404 and the decompressing circuit 408. The decompressing circuit 408 is utilized for decompressing the compressed image data to generate a decompressed image data, and furthermore, the decompressing circuit 408 utilizes an algorithm, which is inverse or corresponding to the algorithm utilized by the compressing apparatus 404, to perform the decompressing operation. If the algorithm utilized by the decompressing circuit 408 is lossless, then the content of the decompressed image data will be equal to the content of the first image data 4022.

Then, the comparing apparatus 410 compares the second image data 4024 and the decompressed image data (if an appropriate compressing algorithm is utilized, decompressed image data will be equal to the first image data) to generate the video driving signal that corresponds to the second image data 4024. In this embodiment, the comparing apparatus 410 comprises an overdrive look-up table 412 (LUT) for generating the above mentioned video driving signal (overdrive signal) by using the overdrive look-up table 412 and according to the comparing result of the second image data 4024 and the decompressed image data. Furthermore, the difference value between the second image data and the video driving signal corresponds to the comparing result.

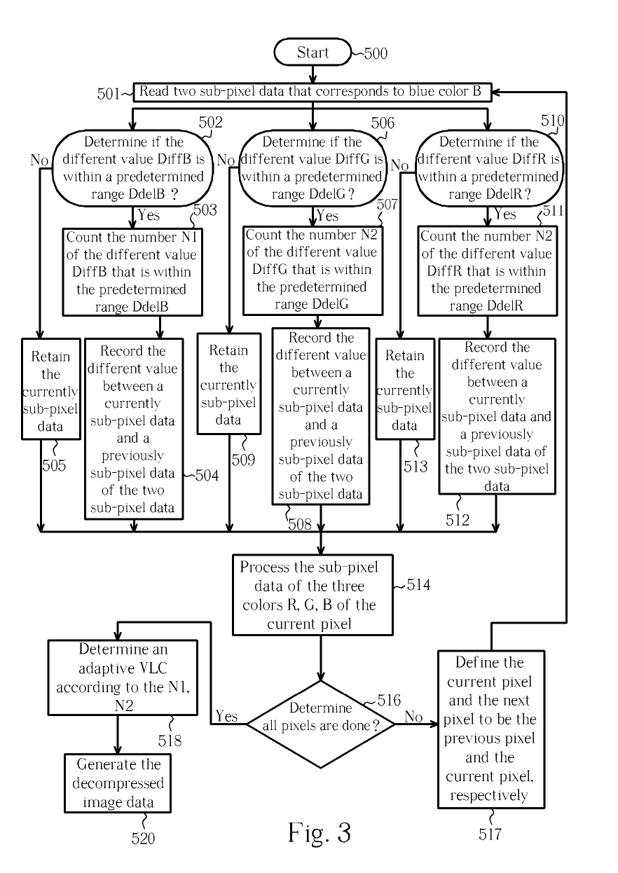

Please refer to FIG. 2 and FIG. 3. FIG. 3 is a flowchart illustrating the compression of the first image data 4022 by utilizing the first algorithm of the compressing apparatus 404. The first algorithm processes each two pixels of the first image data 4022, and the operation is detailed in the following steps:

Step 500: Start;

Step 501: Read two sub-pixel data corresponding to blue color B (corresponding to the previous pixel and the current pixel respectively);

Step 502: Compare the two sub-pixel data corresponding to blue color B (corresponding to the previous pixel and the current pixel respectively) to generate a difference value DiffB and determine if the difference value DiffB is within a predetermined range DdelB. If yes, go to step 503; if no, go to step 505;

Step 503: Count the number of the difference value DiffB that is within the predetermined range DdelB to generate a first counting number N1;

Step 504: Record the difference value between a current sub-pixel data (corresponding to the current pixel) and a previous sub-pixel data (corresponding to the previous pixel) of the two sub-pixel data, and abandon the current sub-pixel data, go to step 514;

Step 505: Retain the current sub-pixel data and do not record the difference value between the previous sub-pixel data and the current sub-pixel data; go to step 514;

Steps 506˜509 and steps 510˜513: Similar to the above mentioned steps 502˜505, and thus omitted here;

Step 514: Process the sub-pixel data of the three colors R, G, B of the current pixel;

Step 516: Determine whether all pixels are processed. If yes, go to step 518; if no, go to step 517;

Step 517: Define the current pixel and the next pixel to be the previous pixel and the current pixel respectively; go to step 501;

Step 518: Determine an adaptive variable-length coding (adaptive VLC) according to the first and second counting value N1, N2; and

Step 520: Perform the adaptive variable-length coding (adaptive VLC) to compress the difference value between two sub-pixels having the same color information of each two pixels data of the first image data 4022 in order to generate the decompressed image data.

The calculating apparatus 414 of the compressing apparatus 404 calculates the difference value DiffB between a pixel data of a first pixel of the first image data 4022 and a pixel data of a second pixel of the first image data 4022. For example, when the first and second pixel data are (000000) and (000010) respectively, then the difference value DiffB is +2. The calculating apparatus 414 then determines if the difference value DiffB is within a predetermined range DdelB, such as +3˜−3; if the difference value DiffB is within +3˜−3, then the first counting unit 416 calculates the number of the difference value DiffB within the predetermined range DdelB to generate a first counting value N1. Referring to the above-mentioned example, the first counting unit 416 will add one to the counting value N1. Conversely, if the calculating apparatus 414 determines that the difference value DiffB is not within +3˜−3, then the compressing unit 420 will retain the 6 bits sub-pixel data of the blue color B in the image data of the second pixel (step 505). Similarly, the second counting unit 418 calculates the number of the difference value DiffG within the predetermined range DdelG, and the number of the difference value DiffR within the predetermined range DdelR to generate (update) a first counting value N1. If the difference value DiffG, DiffR is not within +3˜−3, then the compressing unit 420 will retain the 6 bits sub-pixel data of the green color G in the image data of the second pixel, and retain the 6 bits sub-pixel data of the red color R in the image data of the second pixel (step 509, step 513).

Then, the compressing unit 420 performs a statistical operation on the first and the second counting values N1, N2 to compress the bit difference of the 6 bits sub-pixel data that corresponds to three of the colors (red, green, blue, RGB) between each two pixel data in the first image data 4022 to determine an adaptive variable-length code (adaptive VLC) (step 518). Finally, the compressing unit utilizes the variable-length code to compress the bit difference of the 6 bits sub-pixel data that corresponds to three of the colors (red, green, blue, RGB) between each two pixel data in the first image data 4022 to generate the compressed image data (step 520). The video compressing technique that is performed in step 520 is prior art, and details can be found in the reference: Jeffrey Scott Vitter, “Design and Analysis of Dynamic Huffman Codes”, Journal of the Association for Computing Machinery, Vol. 34, No. 4, October 1987.

Please note that, although the first algorithm processes the blue color B first in step 501, those skilled in this art will readily observe that the order of processing the blue color B, red color R, and green color G can be arbitrary according to system requirements. Furthermore, the color plane of RGB utilized in the present invention is just an example, thus any other transfer function that transfers the coordination of the colors also belongs to the spirit of the present invention. For example, the color plane of YC_{b}Cᵣ, HIS, etc. can also be used.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video driving signal generating method, comprising:
compressing a first image data to generate a compressed data;
buffering the compressed data;
decompressing the compressed data to generate a decompressed image data;
comparing a second image data and the decompressed image data to generate a comparing result; and
generating a video driving signal according to the second image data and the comparing result;
wherein a difference value between the second image data and the video driving signal corresponds to the comparing result.

2. The method of claim 1, wherein the difference value is obtained through the comparing result and an overdrive look up table.

3. The method of claim 1, wherein the step of compressing the first image data to generate the compressed data comprises:
utilizing a difference value between two pixels of the first image data to compress the first image data.

4. The method of claim 3, further comprising:
calculating the difference value between the two pixels to generate a calculated value; and
performing an encoding process according to the calculated value.

5. The method of claim 4, wherein the step of performing the encoding process according to the calculated value performs a variable-length coding (VLC).

6. The method of claim 5, wherein the step of performing the variable-length coding performs an adaptive variable-length coding (adaptive VLC).

7. The method of claim 3, further comprising:
performing an adaptive variable-length coding (adaptive VLC) according to the difference value between the two pixels.

8. A video driving signal generating method, comprising:
compressing a first image data to generate a compressed data;
buffering the compressed data;
decompressing the compressed data to generate a decompressed image data; and
comparing a second image data and the decompressed image data to generate a video driving signal;
wherein the video driving signal corresponds to the second image data.

9. The method of claim 8, wherein the step of comparing the second image data and the decompressed image data to generate the video driving signal comprises:
generating the video driving signal through an overdrive look up table.

10. The method of claim 9, wherein the step of compressing the first image data to generate the compressed data comprises:
utilizing a difference value between two pixels of the first image data to compress the first image data.

11. The method of claim 10, further comprising:
calculating the difference value between the two pixels to generate a calculated value; and
performing an encoding process according to the calculated value.

12. The method of claim 11, wherein the step of performing the encoding process according to the calculated value performs a variable-length coding (VLC).

13. The method of claim 12, wherein the step of performing the variable-length coding performs an adaptive variable-length coding (adaptive VLC).

14. The method of claim 10, comprising:
performing an adaptive variable-length coding (adaptive VLC) according to the difference value between the two pixels.

15. A video driving signal generating apparatus, comprising:
a compressing unit, for compressing a first image data to generate a compressed data;
a buffering unit, for buffering the compressed data;
a decompressing unit, for decompressing the compressed data to generate a decompressed image data; and
a comparing unit, for comparing a second image data and the decompressed image data to generate a video driving signal;
wherein the video driving signal corresponds to the second image data.

16. The apparatus of claim 15, wherein the comparing unit is an overdrive look-up table (LUT).

17. The apparatus of claim 15, wherein the compressing unit comprises:
a calculating unit, for calculating the difference value between the two pixels of the first image data;
a counting unit, for counting the difference value between the two pixels of the first image data to generate a counting value; and
a compressing device, for compressing the difference value between the two pixels of the first image data according to the counting value.

18. The apparatus of claim 17, wherein the compressing unit performs a coding process according to the counting value to compress the difference value between the two pixels of the first image data.

19. The apparatus of claim 18, wherein the coding process is a variable-length coding (VLC).

20. The apparatus of claim 19, wherein the variable-length coding (VLC) is an adaptive variable-length coding (adaptive VLC).
